(19) United States
(12) Patent Application Publication
(10) Pub. No.: US 2015/0310816 A1
(43) Pub. Date: Oct. 29, 2015

(54) SOURCE DRIVER AND CONTROL METHOD THEREOF AND DISPLAY DEVICE

(71) Applicant: Novatek Microelectronics Corp., Hsinchu (TW)

(72) Inventors: Syang-Yun Tzeng, Taoyuan County (TW); Ju-Lin Huang, Hsinchu County (TW)

(21) Appl. No.: 14/676,801

(22) Filed: Apr. 1, 2015

Related U.S. Application Data
(60) Provisional application No. 61/985,453, filed on Apr. 28, 2014.

(30) Foreign Application Priority Data
Dec. 5, 2014 (TW) 103142412

(51) Int. Cl. G09G 3/36

(52) U.S. Cl. CPC G09G 3/3614; G09G 3/3677; G09G 2300/0823; G09G 2310/0208; G09G 2310/0278

(57) ABSTRACT

A source driver, a control method thereof and a display device are provided. The source driver includes a plurality of first channels, a plurality of second channels, a first conductor, a second conductor, a plurality of first switches and a plurality of second switches. During a driving period, the outputs of the first channels belong to a first polarity, and the outputs of the second channels belong to a second polarity different from the first polarity. The first terminals of the first switches are coupled to the first conductor. The second terminals of the first switches are coupled to the output terminals of the first channels, respectively. The first terminals of the second switches are coupled to the second conductor. The second terminals of the second switches are coupled to the output terminals of the second channels, respectively.

### CROSS-REFERENCE TO RELATED APPLICATION

This application claims the priority benefits of U.S. provisional application Ser. No. 61/985,453, filed on Apr. 28, 2014 and Taiwan application serial no. 103142412, filed on Dec. 5, 2014. The entirety of each of the above-mentioned patent applications is hereby incorporated by reference herein and made a part of this specification.

### BACKGROUND OF THE INVENTION

1. Field of the Invention

The invention relates to an electronic device, and more particularly, relates to a source driver, a control method of the source driver and a display device.

2. Description of Related Art

A source driver is an indispensable element in a driving circuit of a display device. The source driver is an indispensable element configured to convert a digital image data signal into an analog pixel voltage and provide the pixel voltage to a pixel being activated via different data lines of a display panel, so as to store the pixel voltage into a storage capacitor in the pixel. Due to the nature of liquid crystals, when the source driver drives the liquid crystals, it is required to frequently perform a polarity inversion for the liquid crystals. Based on different demands for energy, various driving modes of the polarity inversion for the liquid crystals have been developed. For example, the driving modes of the polarity inversion may include a column inversion mode, a dot inversion or other modes of the polarity inversion.

In order to reduce a power consumption of the source driver, a charge sharing technology is used for sharing charge between two adjacent data lines belong to different polarities. A charge sharing function of the conventional source driver only activates during an initial period of the polarity inversion. In any case, such as in the application of the column inversion, the same channel of the source driver outputs the pixel voltage of the same polarity during the same frame period. As such, the conventional source driver can conduct a charge sharing only once during the same period.

### SUMMARY OF THE INVENTION

The invention provides a source driver, a control method of the source driver and a display device, which are capable of reducing a power consumption of the source driver.

A source driver is provided according to an embodiment of the invention, and the source driver includes a plurality of first channels, a plurality of second channels, a first charge sharing conductor, a second charge sharing conductor, a plurality of first switches and a plurality of second switches. The first channels and the second channels are configured to drive different data lines of a display panel individually. During a driving period, outputs of the first channels belong to a first polarity, and outputs of the second channels belong to a second polarity different from the first polarity. First terminals of the first switches are coupled to the first charge sharing conductor. Second terminals of the first switches are individually coupled to output terminals of the first channels in one-to-one manner. The second charge sharing conductor is electrically isolated from the first charge sharing conductor. First terminals of the second switches are coupled to the second charge sharing conductor. Second terminals of the second switches are individually coupled to output terminals of the second channels in one-to-one manner.

A source driver is provided according to an embodiment of the invention, and the source driver includes a plurality of first channels, a plurality of second channels, one or more first charge sharing conductors, one or more second charge sharing conductors, one or more first switch groups and one or more second switch groups. The first channels and the second channels are configured to drive different data lines of a display panel individually. During a driving period, the outputs of the first channels belong to a first polarity, and the outputs of the second channels belong to a second polarity different from the first polarity. The one or more first switch groups are respectively corresponding to the one or more first charge sharing conductors. Each of the one or more first switch groups includes a plurality of first switches. First terminals of the first switches are coupled to the corresponding first charge sharing conductor, and second terminals of the first switches are individually coupled to output terminals of the first channels in one-to-one manner. The one or more second charge sharing conductors are electrically isolated from the one or more first charge sharing conductors. The one or more second switch groups are respectively corresponding to the one or more second charge sharing conductors. Each of the one or more second switch groups includes a plurality of second switches. First terminals of the second switches are coupled to the corresponding second charge sharing conductor, and second tell finals of the second switches are individually coupled to output terminals of the second channels in one-to-one manner.

A display device is provided according an embodiment of the invention, and the display device includes a display panel and a source driver. The source driver is used to drive a display panel. The source driver includes a plurality of first channels, a plurality of second channels, a first charge sharing conductor, a second charge sharing conductor, a plurality of first switches and a plurality of second switches. The first channels and the second channels are configured to drive different data lines of a display panel individually. During a driving period, the outputs of the first channels belong to a first polarity, and the outputs of the second channels belong to a second polarity different from the first polarity. First terminals of the first switches are coupled to the first charge sharing conductor, and second terminals of the first switches are individually coupled to output terminals of the first channels in one-to-one manner. The second charge sharing conductor is electrically isolated from the first charge sharing conductor. First terminals of the second switches are coupled to the second charge sharing conductor, and second terminals of the second switches are individually coupled to output terminals of the second channels in one-to-one manner.

A control method of the display device is provided according an embodiment of the invention. The source driver includes the first channels and the second channels. The first switches are individually coupled to the first channels, and the second switches are individually coupled to the second channels. The control method comprises: receiving a control signal by the first switches and the second switches to determine a charge sharing mode, wherein the first channels share charge with each other when the first switches is turned on, and the second channels share charge with each other when the second switches is turned on.

Based on the above, the source driver and the display device according to the embodiments of the invention are capable of allowing the channels that belong to the same polarity to share charge with one another via the charge sharing conductors, so as to reduce the power consumption of the source driver.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are schematic diagrams illustrating a layout of a display panel of a display device according an embodiment of the invention.

FIG. 2 is a schematic diagram illustrating circuitry of a source driver according to an embodiment of the invention.

FIG. 3 is a block diagram illustrating circuitry of the channel CH(N+1) depicted in FIG. 2 according to an embodiment of the invention.

FIG. 4 is a schematic diagram illustrating a waveform of the latch signal LD depicted in FIG. 2 and FIG. 3 according to an embodiment of the invention.

FIG. 5 illustrates a schematic diagram of waveforms when the source driver depicted in FIG. 2 outputs a red display frame to the display panel depicted in FIG. 1A according to an embodiment of invention.

FIG. 6 is a partial waveform diagram of the data lines S(N+1), S(N+3) and S(N+5) depicted in FIG. 5.

FIG. 7 is a partial waveform diagram of the data lines S(N+2), S(N+4) and S(N+6) depicted in FIG. 5.

FIG. 8 illustrates a schematic diagram of waveforms when the source driver depicted in FIG. 2 outputs a green display frame to the display panel depicted in FIG. 1A according to another embodiment of invention.

FIG. 9 is a partial waveform diagram of the data lines S(N+1), S(N+3) and S(N+5) depicted in FIG. 8.

FIG. 10 is a partial waveform diagram of the data lines S(N+2), S(N+4) and S(N+6) depicted in FIG. 8.

FIG. 11 illustrates a schematic diagram of waveform when the source driver depicted in FIG. 2 outputs a blue display frame to the display panel depicted in FIG. 1A according to yet another embodiment of invention.

FIG. 12 is a partial waveform diagram of the data lines S(N+1), S(N+3) and S(N+5) depicted in FIG. 11.

FIG. 13 is a partial waveform diagram of the data lines S(N+2), S(N+4) and S(N+6) depicted in FIG. 11.

FIG. 14 illustrates a schematic diagram of waveforms when the source driver depicted in FIG. 2 outputs a cyan display frame to the display panel depicted in FIG. 1A according to still another embodiment of invention.

FIG. 15 is a partial waveform diagram of the data lines S(N+1), S(N+3) and S(N+5) depicted in FIG. 14.

FIG. 16 is a partial waveform diagram of the data lines S(N+2), S(N+4) and S(N+6) depicted in FIG. 14.

FIG. 17 illustrates a schematic diagram of waveforms when the source driver depicted in FIG. 2 outputs a magenta display frame to the display panel depicted in FIG. 1A according to still another embodiment of invention.

FIG. 18 is a partial waveform diagram of the data lines S(N+1), S(N+3) and S(N+5) depicted in FIG. 17.

FIG. 19 is a partial waveform diagram of the data lines S(N+2), S(N+4) and S(N+6) depicted in FIG. 17.

FIG. 20 illustrates a schematic diagram of waveforms when the source driver depicted in FIG. 2 outputs a yellow display frame to the display panel depicted in FIG. 1A according to still another embodiment of invention.

FIG. 21 is a partial waveform diagram of the data lines S(N+1), S(N+3) and S(N+5) depicted in FIG. 20.

FIG. 22 is a partial waveform diagram of the data lines S(N+2), S(N+4) and S(N+6) depicted in FIG. 20.

FIG. 23 is a schematic diagram illustrating circuitry of a source driver according to another embodiment of the invention.

FIG. 24 is a schematic diagram illustrating circuitry of a source driver according to yet another embodiment of the invention.

FIG. 25 is a schematic diagram illustrating circuitry of a source driver according to still another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The term “coupling/coupled” used in this specification (including claims) may refer to any direct or indirect connection means. For example, “a first device is coupled to a second device” should be interpreted as “the first device is directly connected to the second device” or “the first device is indirectly connected to the second device through other devices or connection means.” Moreover, wherever appropriate in the drawings and embodiments, elements/components/steps with the same reference numerals represent the same or similar parts. Elements/components/steps with the same reference numerals or names in different embodiments may be cross-referenced.

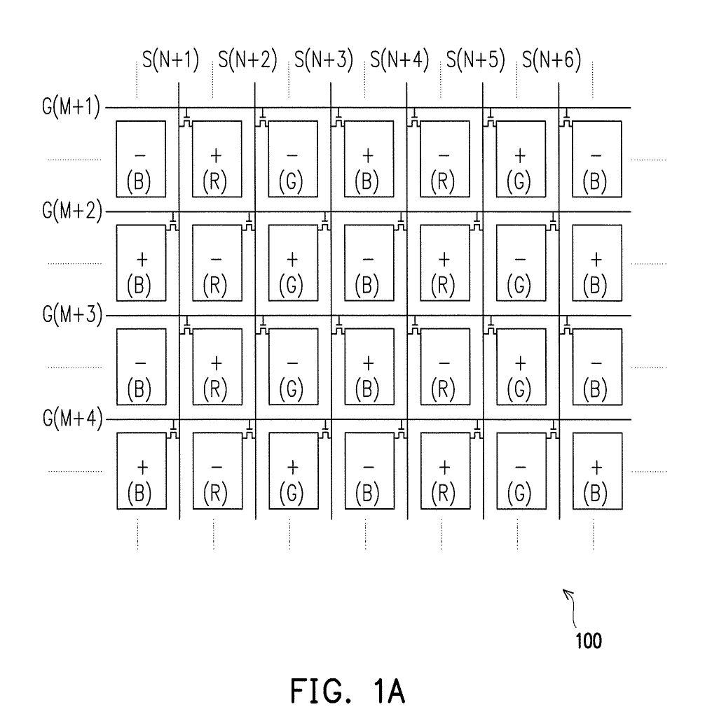

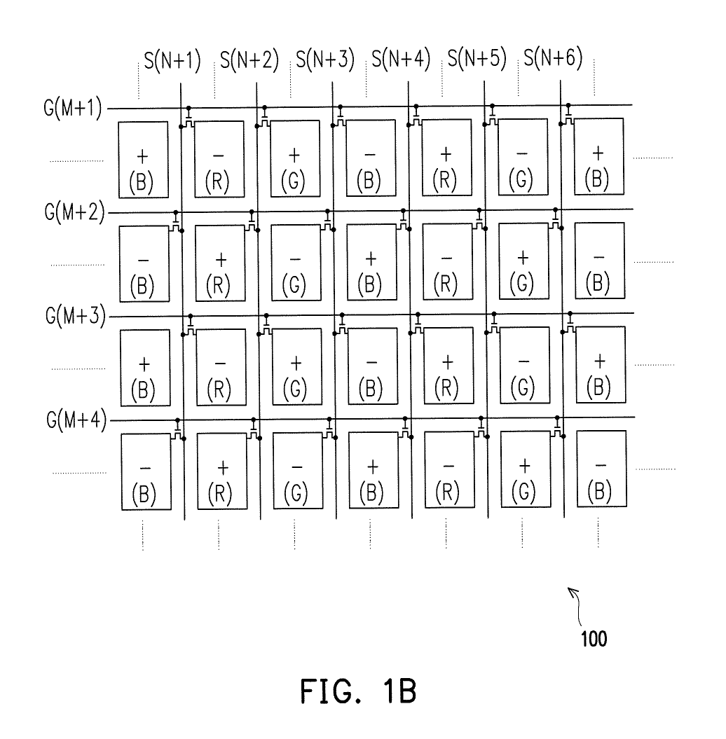

FIG. 1A and FIG. 1B are schematic diagrams illustrating a layout of a display panel of a display device 100 according an embodiment of the invention. The display panel 100 depicted in the present embodiment has a Zigzag pixel structure, but the invention should not be limited thereto. In other embodiments, the display panel 100 may be a display panel of any other types/structures. In FIG. 1A and FIG. 1B, a block marked by “(B)” indicates a blue pixel, a block marked by “(R)” indicates a red pixel, and a block marked by “(G)” indicates a green pixel. Gates of switch transistors of the pixels are coupled to corresponding gate lines (or known as scan lines), such as scan lines G(M+1), G(M+2), G(M+3) and G(M+4) depicted in FIG. 1A and FIG. 1B. Sources of the switch transistors of the pixels are coupled to corresponding source lines (or known as data lines), such as data lines S(N+1), S(N+2), S(N+3), S(N+4), S(N+5) and S(N+6) depicted in FIG. 1A and FIG. 1B.

A source driver (which will be described in detail later) drives the display panel 100 by a column inversion mode. FIG. 1A illustrates polarities of the pixels of the display panel 100 during an odd-numbered frame period (e.g., a first frame period). In FIG. 1A, a block marked by “+” indicates the pixel that belongs to a positive polarity, and a block marked by “−” indicates the pixel that belongs to a negative polarity. During the odd-numbered frame period, in accordance with a scan time sequence of the scan lines G(M+1) to G(M+4), the source driver (which will be described in detail later) may use the data line S(N+1), S(N+3) and S(N+5) to transmit the pixel voltage of the positive polarity to the corresponding pixels, and use the data line S(N+2), S(N+4) and S(N+6) to transmit the pixel voltage of the negative polarity to the corresponding pixels. FIG. 1B illustrates the polarities of the pixels of the display panel 100 during an even-numbered frame period (e.g., a second frame period). During the even-numbered frame period, in accordance with the scan time sequence of the scan lines G(M+1) to G(M+4), the source driver (which will be described in detail later) may use the data line S(N+1), S(N+3) and S(N+5) to transmit the pixel voltage of the negative polarity to the corresponding pixels, and use the data line S(N+2), S(N+4) and S(N+6) to transmit the pixel voltage of the positive polarity to the corresponding pixels.

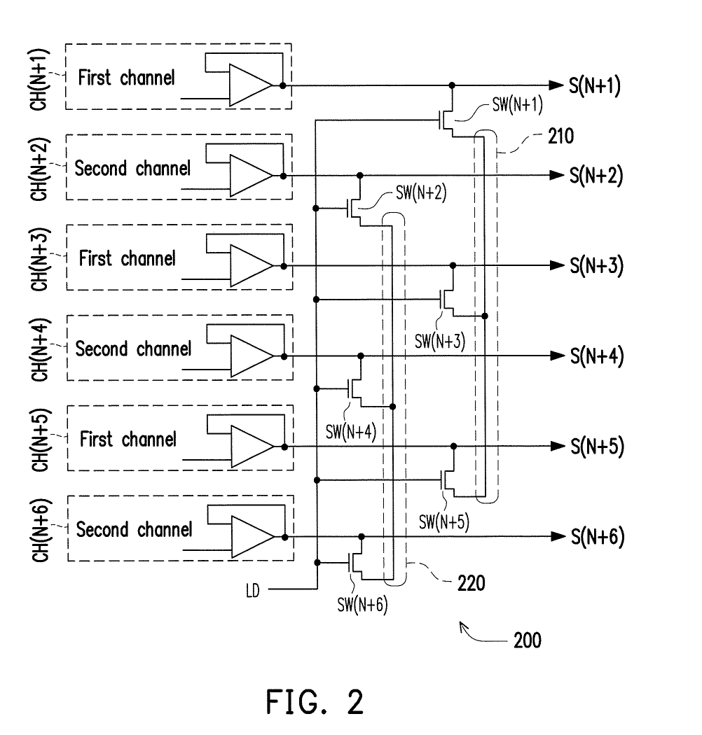

FIG. 2 is a schematic diagram illustrating circuitry of a source driver 200 according to an embodiment of the invention. The source driver 200 may latch image data according to a latch signal LD. The source driver 200 includes a plurality of first channels and a plurality of second channels. The first channels and the second channels may be disposed in the source driver 200 by any arranged structure. For instance, in some embodiments, the first channels may be odd-numbered channels (e.g., channels CH(N+1), CH(N+3) and CH(N+5)) of the source driver 200, and the second channels may be even-numbered channels (e.g., channels CH(N+2), CH(N+4) and CH(N+6)) of the source driver 200. The channels are configured to drive different data lines of the display panel individually. For example (but the invention is not limited thereto), output terminals of the channels CH(N+1) to CH(N+6) may be respectively coupled to the data lines S(N+1) to S(N+6) of the display panel 100 depicted in FIG. 1A and FIG. 1B.

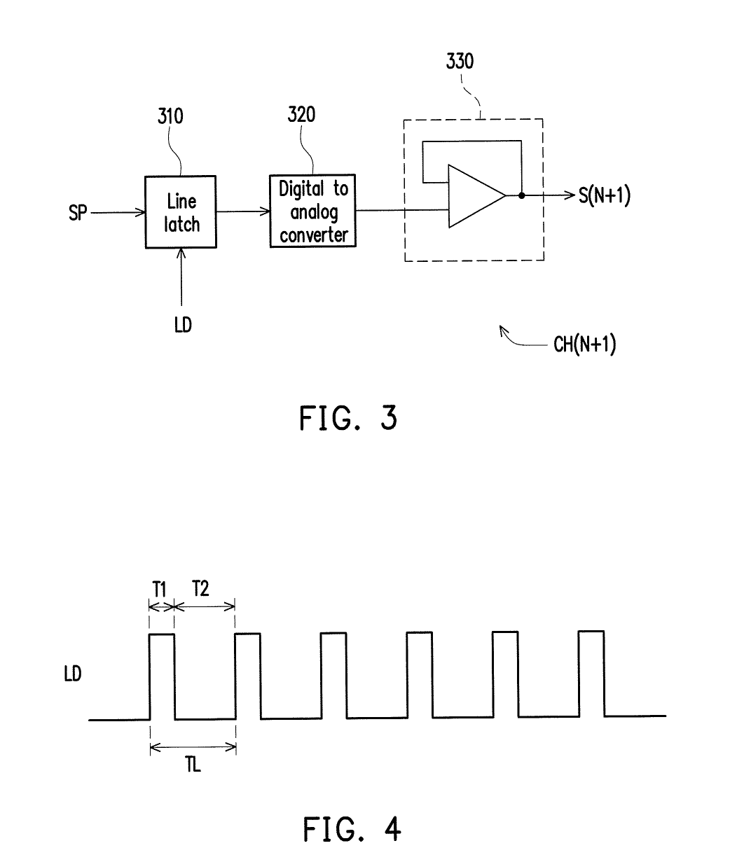

The present embodiment is not intended to limit implementations of the channels CH(N+1) to CH(N+6). For instance, FIG. 3 is a block diagram illustrating circuitry of the channel CH(N+1) depicted in FIG. 2 according to an embodiment of the invention. The other channels CH(N+2) to CH(N+6) depicted in FIG. 2 may be inferred by reference with related description for the channel CH(N+1). Referring to FIG. 3, the channel CH(N+1) may include a line latch 310, a digital to analog converter (DAC) 320 and an output buffer 330. The line latch 310 may latch/sample sub-pixel data SP in the image data according to a triggering time sequence of the latch signal LD and output the latched sub-pixel data to the digital to analog converter 320.

FIG. 4 is a schematic diagram illustrating a waveform of the latch signal LD depicted in FIG. 2 and FIG. 3 according to an embodiment of the invention. A period TL depicted in FIG. 4 represents a scan line period. Referring to FIG. 3 and FIG. 4, when a pulse occurs on the latch signal LD (i.e., a sampling period T1 depicted in FIG. 4), the line latch 310 is triggered by such pulse to latch/sample the sub-pixel data SP. During the sampling period T1, an output of line latch 310 retains at a previous data, and an output of the output buffer 330 retains at a high impedance (or known as high-Z) state. When the pulse of the latch signal LD ends (i.e., a driving period T2 depicted in FIG. 4), an output terminal of the line latch 310 outputs the latched sub-pixel data to the digital to analog converter 320.

Referring to FIG. 3, an input terminal of the digital to analog converter 320 is coupled to the output terminal of the line latch 310 to receive the latched sub-pixel data. The digital to analog converter 320 may convert the digital sub-pixel data into the analog pixel voltage. After being gained by the output buffer 330, the pixel voltage is transmitted to the data line S(N+1) of the display panel 100.

Referring to FIG. 2, during the driving period T2, outputs of the first channels (e.g., the channels CH(N+1), CH(N+3) and CH(N+5)) belong to a first polarity, and outputs of the second channels (e.g., the channels CH(N+2), CH(N+4) and CH(N+6)) belong to a second polarity (which is different from the first polarity). For instance, referring to FIG. 1A and FIG. 2, the channels CH(N+1), CH(N+3) and CH(N+5) may transmit the pixel voltage that belongs to the positive polarity to the corresponding pixels via the data lines S(N+1), S(N+3) and S(N+5), and the channels CH(N+2), CH(N+4) and CH(N+6) may transmit the pixel voltage that belongs to the negative polarity to the corresponding pixels via the data lines S(N+2), S(N+4) and S(N+6). In another frame period, referring to FIG. 1B and FIG. 2, the channels CH(N+1), CH(N+3) and CH(N+5) may transmit the pixel voltage of the negative polarity to the corresponding pixels via the data lines S(N+1), S(N+3) and S(N+5), and the channels CH(N+2), CH(N+4) and CH(N+6) may transmit the pixel voltage of the positive polarity to the corresponding pixels via the data lines S(N+2), S(N+4) and S(N+6).

The source driver 200 depicted in FIG. 2 further includes a first charge sharing conductor 210, a second charge sharing conductor 220, a plurality of first switches (e.g., switches SW(N+1), SW(N+3) and SW(N+5)) and a plurality of second switches (e.g., switches SW(N+2), SW(N+4) and SW(N+6)). The second charge sharing conductor 220 is electrically isolated from the first charge sharing conductor 210. First terminals of the switches SW(N+1), SW(N+3) and SW(N+5) are coupled to the first charge sharing conductor 210, and second terminals of the switches SW(N+1), SW(N+3) and SW(N+5) are individually coupled to the output terminals of the channels CH(N+1), CH(N+3) and CH(N+5) in one-to-one manner. First terminals of the switches SW(N+2), SW(N+4) and SW(N+6) are coupled to the second charge sharing conductor 220, and second terminals of the switches SW(N+2), SW(N+4) and SW(N+6) are individually coupled to the output terminals of the channels CH(N+2), CH(N+4) and CH(N+6) in one-to-one manner.

During a charge sharing period, the first switches (e.g., the switches SW(N+1), SW(N+3) and SW(N+5)) are simultaneously turned on so that the different first channels (e.g., the channels CH(N+1), CH(N+3) and CH(N+5)) coupled to the first switches share charge with one another, and the second switches (e.g., the switches SW(N+2), SW(N+4) and SW(N+6)) are also simultaneously turned on so that the different second channels (e.g., the channels CH(N+2), CH(N+4) and CH(N+6)) coupled to the second switches share charge with one another. Therein, the charge sharing period may occur within each period among a plurality of consecutive scan line periods TL. For instance, the charge sharing period may occur in the sampling period T1.

In the embodiment depicted in FIG. 2, control terminals of the switches SW(N+1) to SW(N+6) are commonly coupled to the same control signal (e.g., the latch signal LD). However, in other embodiments, a control mechanism of the switches SW(N+1) to SW(N+6) is not limited thereto. In some other embodiments, the control mechanism of the switches SW(N+1) to SW(N+6) is not limited by the same control signal. The switches SW(N+1) to SW(N+6) may be controlled by different control signals, respectively. Therein, the switches SW(N+1) to SW(N+6) are turned on once per one scan line period TL. In other words, on and off states of switches SW(N+1) to SW(N+6) are unrelated to a content of an image frame processed by the source driver 200. In other embodiments, a number of the channels for charge sharing may be two, four, five or more.

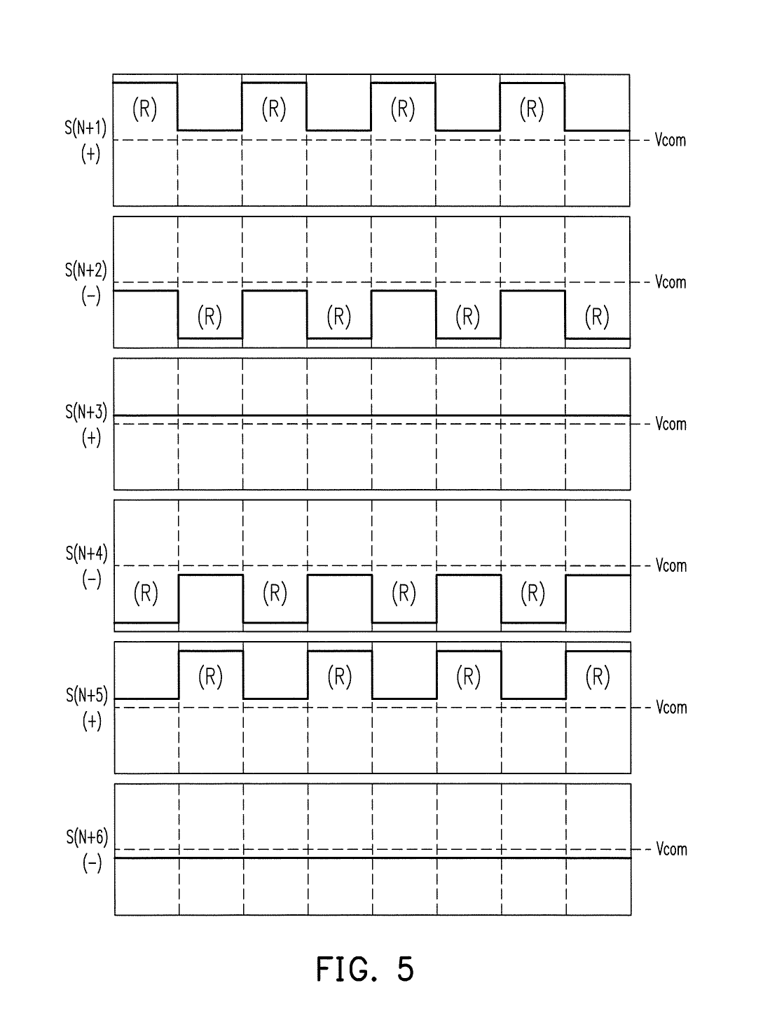

For instance, FIG. 5 illustrates a schematic diagram of waveforms when the source driver 200 depicted in FIG. 2 outputs a red display frame to the display panel 100 depicted in FIG. 1A according to an embodiment of invention. In FIG. 5, a horizontal axis represents a time, and a vertical axis represents a voltage, wherein a dashed line represents a common voltage Vcom of the display panel 100. When the pixel voltage is greater than the common voltage Vcom, this pixel voltage belongs to the positive polarity. Conversely, when the pixel voltage is less than the common voltage Vcom, this pixel voltage belongs to the negative polarity. The source driver 200 drives the display panel 100 by a column inversion mode. When the source driver 200 depicted in FIG. 2 outputs the red display frame to the display panel 100 depicted in FIG. 1A, the waveforms of the data lines S(N+1) to S(N+6) are as shown in FIG. 5.

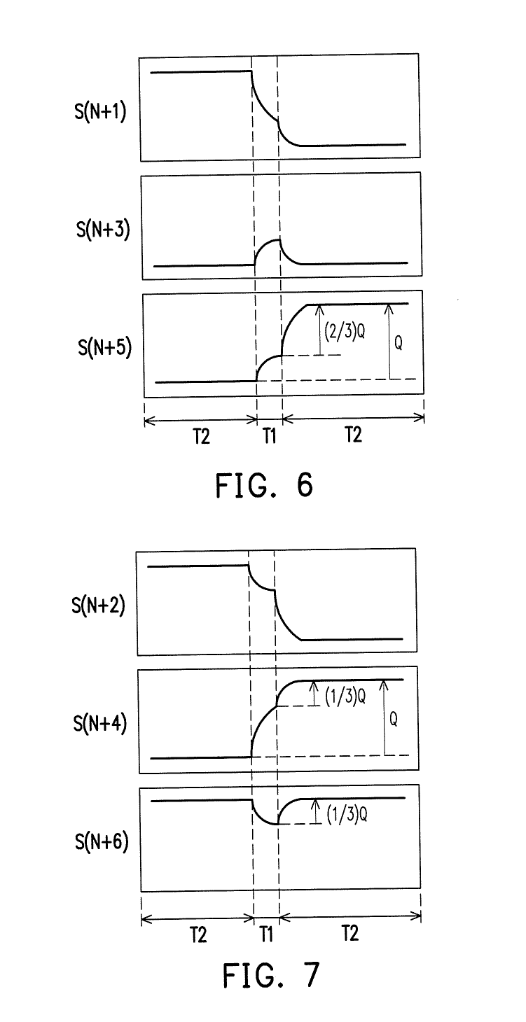

FIG. 6 is a partial waveform diagram of the data lines S(N+1), S(N+3) and S(N+5) depicted in FIG. 5. After the driving period T2 ends, the charge sharing period is entered (e.g., the sampling period T1). Referring to FIG. 2 and FIG. 6, during the sampling period T1, the first switches (e.g., the switches SW(N+1), SW(N+3) and SW(N+5)) are turned on, such that the output terminals of the first channels (e.g., the channels CH(N+1), CH(N+3) and CH(N+5)) are commonly coupled to the first charge sharing conductor 210. Therefore, the data lines S(N+1), S(N+3) and S(N+5) may share charge with one another via the first charge sharing conductor 210 during the sampling period T1, as shown in FIG. 6. After the sampling period T1 ends, the driving period T2 is entered. It is assumed that an electric quantity of the channel CH(N+5) for driving the data line S(N+5) during the driving period T2 is Q in the condition where the charge sharing is absent. In view of FIG. 6, because the switches SW(N+1) to SW(N+6) are turned on during each sampling period T1, the electric quantity of the channel CH(N+5) for driving the data line S(N+5) is reduced to approximately (⅔)Q.

FIG. 7 is a partial waveform diagram of the data lines S(N+2), S(N+4) and S(N+6) depicted in FIG. 5. Referring to FIG. 2 and FIG. 7, during the sampling period T1 (the charge sharing period), the second switches (e.g., the switches SW(N+2), SW(N+4) and SW(N+6)) are turned on, such that the output terminals of the second channels (e.g., the channels CH(N+2), CH(N+4) and CH(N+6)) are commonly coupled to the second charge sharing conductor 220. Therefore, the data lines S(N+2), S(N+4) and S(N+6) may share charge with one another via the second charge sharing conductor 220 during the sampling period T1, as shown in FIG. 7. It is assumed that an electric quantity of the channel CH(N+4) for driving the data line S(N+4) during the driving period T2 is Q in the condition where the charge sharing is absent. In view of FIG. 7, the electric quantity of the channel CH(N+4) for driving the data line S(N+4) is reduced to approximately (⅓)Q. Although the electric quantity of the channel CH(N+6) for driving the data line S(N+6) is increased by approximately (⅓)Q, an overall driving electric quantity of the second channels (the channels CH(N+2), CH(N+4) and CH(N+6)) is approximately (⅓)Q+(⅓)Q=(⅔)Q, which is still less than the driving electric quantity Q in the condition where the charge sharing is absent.

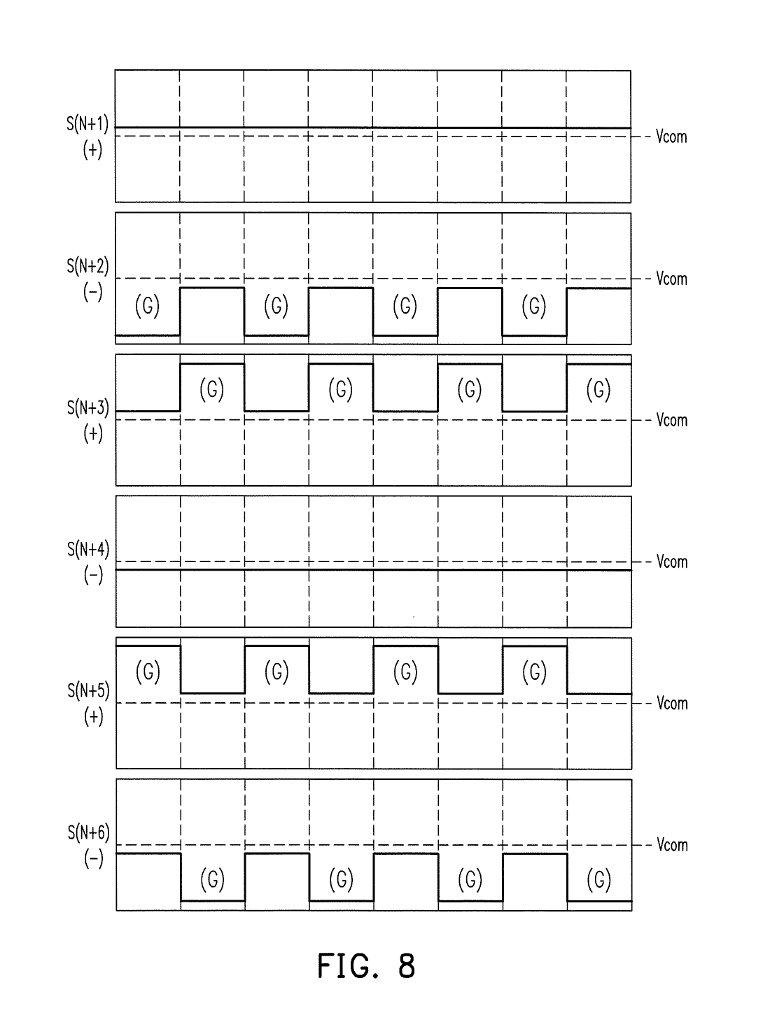

As another example, FIG. 8 illustrates a schematic diagram of waveforms when the source driver 200 depicted in FIG. 2 outputs a green display frame to the display panel 100 depicted in FIG. 1A according to another embodiment of invention. In FIG. 8, a horizontal axis represents a time, and a vertical axis represent a voltage, wherein a dashed line represents a common voltage Vcom of the display panel 100. When the source driver 200 depicted in FIG. 2 outputs the green display frame to the display panel 100 depicted in FIG. 1A, the waveforms of the data lines S(N+1) to S(N+6) are as shown in FIG. 8.

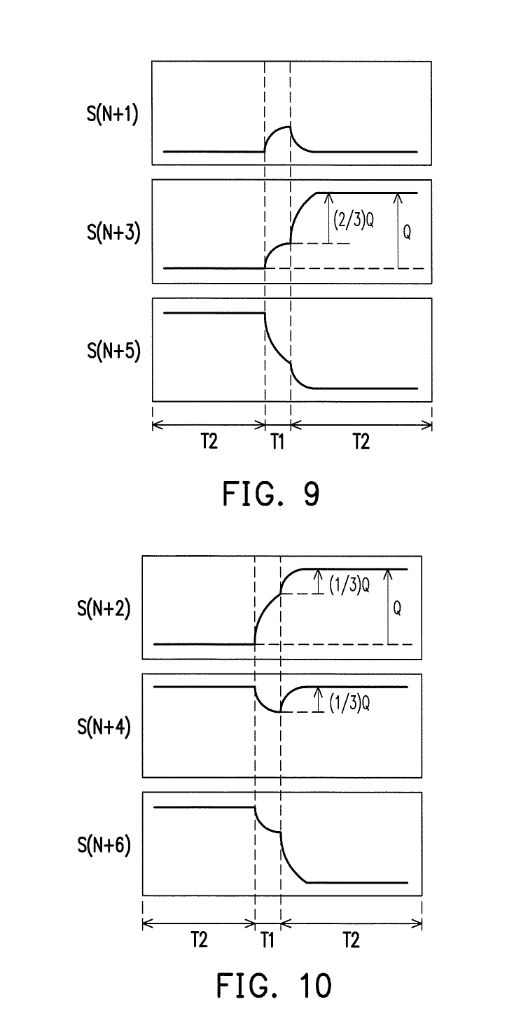

FIG. 9 is a partial waveform diagram of the data lines S(N+1), S(N+3) and S(N+5) depicted in FIG. 8. Referring to FIG. 2 and FIG. 9, during the sampling period T1 (the charge sharing period), the data lines S(N+1), S(N+3) and S(N+5) may share charge with one another via the first charge sharing conductor 210. After the sampling period T1 ends, the driving period T2 is entered. It is assumed that an electric quantity of the channel CH(N+3) for driving the data line S(N+3) during the driving period T2 is Q in the condition where the charge sharing is absent. In view of FIG. 9, the electric quantity of the channel CH(N+3) for driving the data line S(N+3) is reduced to approximately (⅔)Q.

FIG. 10 is a partial waveform diagram of the data lines S(N+2), S(N+4) and S(N+6) depicted in FIG. 8. Referring to FIG. 2 and FIG. 10, during the sampling period T1 (the charge sharing period), the data lines S(N+2), S(N+4) and S(N+6) may share charge with one another via the second charge sharing conductor 220. It is assumed that an electric quantity of the channel CH(N+2) for driving the data line S(N+2) during the driving period T2 is Q in the condition where the charge sharing is absent. In view of FIG. 10, the electric quantity of the channel CH(N+2) for driving the data line S(N+2) is reduced to approximately (⅓)Q. Although the electric quantity of the channel CH(N+4) for driving the data line S(N+4) is increased by approximately (⅓)Q, an overall driving electric quantity of the second channels (the channels CH(N+2), CH(N+4) and CH(N+6)) is approximately (⅓)Q+(⅓)Q=(⅔)Q, which is still less than the driving electric quantity Q in the condition where the charge sharing is absent.

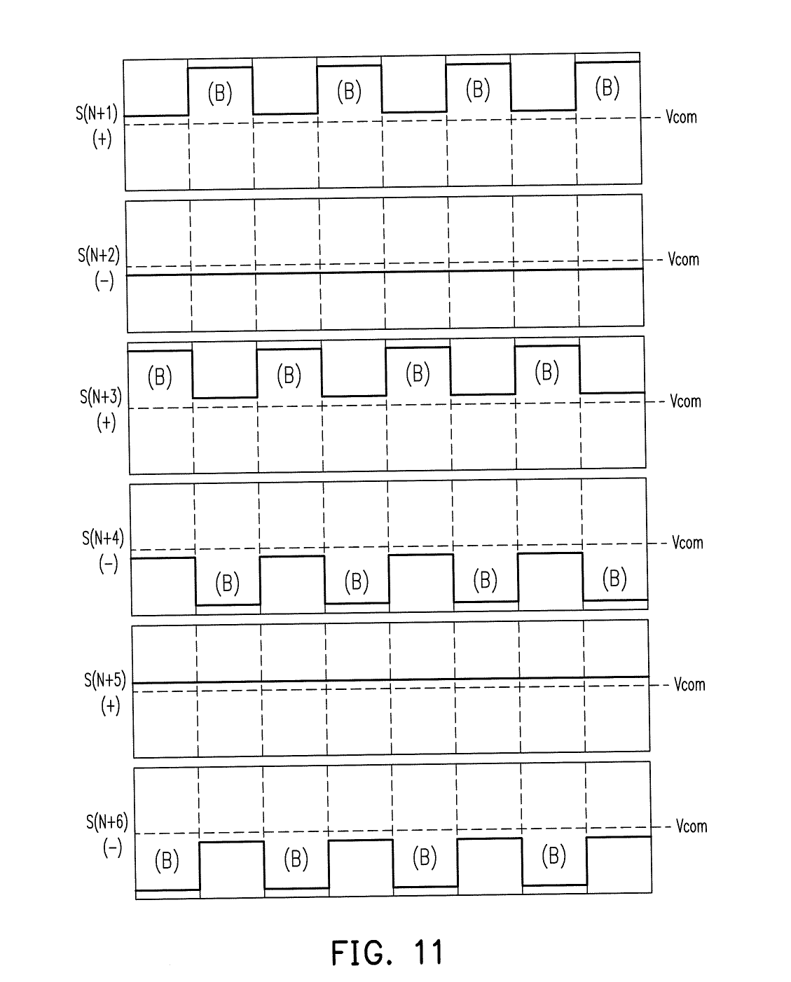

FIG. 11 illustrates a schematic diagram of waveforms when the source driver 200 depicted in FIG. 2 outputs a blue display frame to the display panel 100 depicted in FIG. 1A according to yet another embodiment of invention. In FIG. 11, a horizontal axis represents a time, and a vertical axis represent a voltage, wherein a dashed line represents a common voltage Vcom of the display panel 100. When the source driver 200 depicted in FIG. 2 outputs the blue display frame to the display panel 100 depicted in FIG. 1A, the waveforms of the data lines S(N+1) to S(N+6) are as shown in FIG. 11.

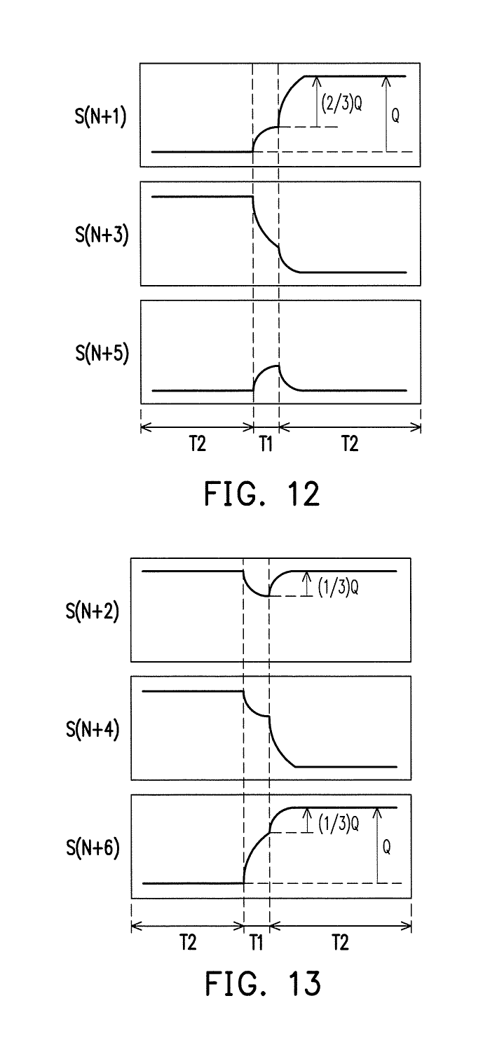

FIG. 12 is a partial waveform diagram of the data lines S(N+1), S(N+3) and S(N+5) depicted in FIG. 11. Referring to FIG. 2 and FIG. 12, during the sampling period T1 (the charge sharing period), the data lines S(N+1), S(N+3) and S(N+5) may share charge with one another via the first charge sharing conductor 210. After the sampling period T1 ends, the driving period T2 is entered. It is assumed that an electric quantity of the channel CH(N+1) for driving the data line S(N+1) during the driving period T2 is Q in the condition where the charge sharing is absent. In view of FIG. 12, the electric quantity of the channel CH(N+1) for driving the data line S(N+1) is reduced to approximately (⅔)Q.

FIG. 13 is a partial waveform diagram of the data lines S(N+2), S(N+4) and S(N+6) depicted in FIG. 11. Referring to FIG. 2 and FIG. 13, during the sampling period T1 (the charge sharing period), the data lines S(N+2), S(N+4) and S(N+6) may share charge with one another via the second charge sharing conductor 220. It is assumed that an electric quantity of the channel CH(N+6) for driving the data line S(N+6) during the driving period T2 is Q in the condition where the charge sharing is absent. In view of FIG. 13, the electric quantity of the channel CH(N+6) for driving the data line S(N+6) is reduced to approximately (⅓)Q. Although the electric quantity of the channel CH(N+2) for driving the data line S(N+2) is increased by approximately (⅓)Q, an overall driving electric quantity of the second channels (the channels CH(N+2), CH(N+4) and CH(N+6)) is approximately (⅓)Q+(⅓)Q=(⅔)Q, which is still less than the driving electric quantity Q in the condition where the charge sharing is absent.

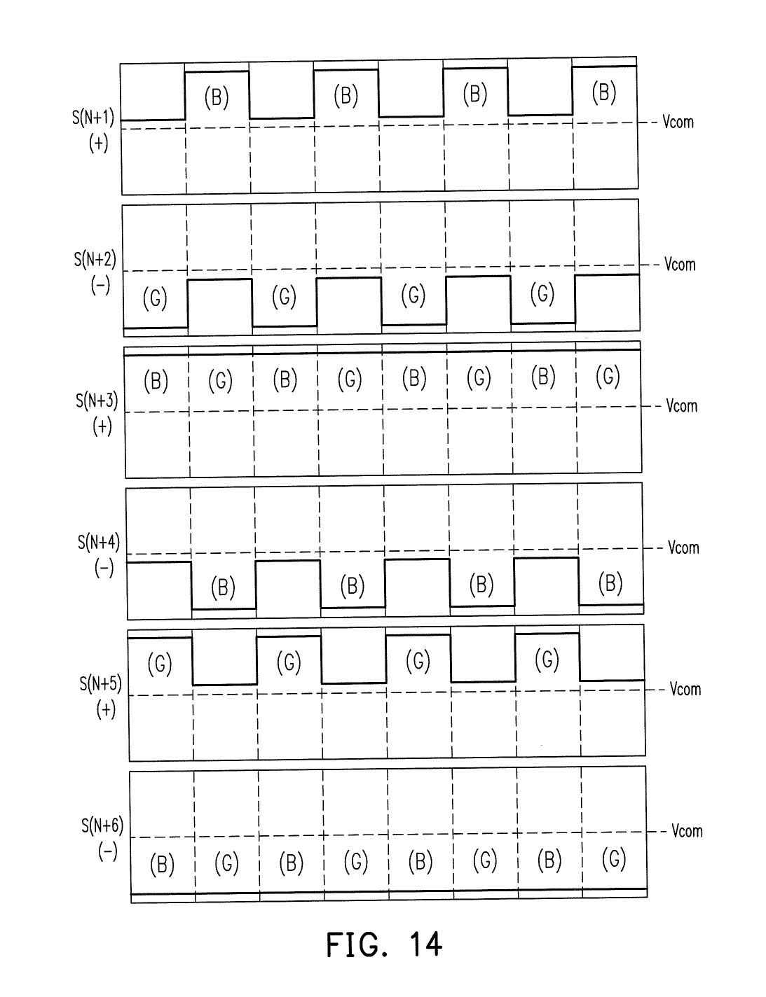

FIG. 14 illustrates a schematic diagram of waveforms when the source driver 200 depicted in FIG. 2 outputs a cyan display frame to the display panel 100 depicted in FIG. 1A according to still another embodiment of invention. In FIG. 14, a horizontal axis represents a time, and a vertical axis represents a voltage, wherein a dashed line represents a common voltage Vcom of the display panel 100. When the source driver 200 depicted in FIG. 2 outputs the cyan display frame to the display panel 100 depicted in FIG. 1A, the waveforms of the data lines S(N+1) to S(N+6) are as shown in FIG. 14.

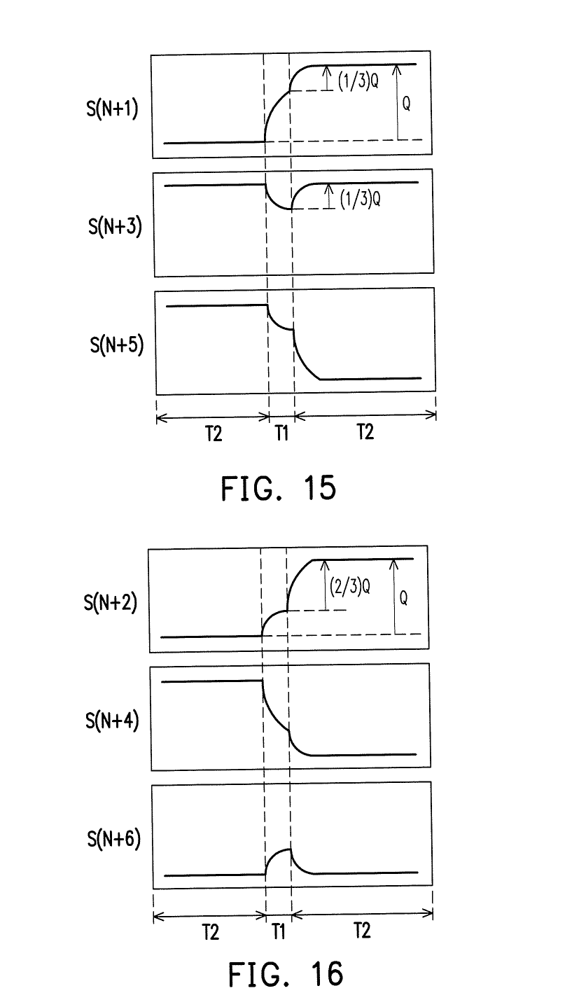

FIG. 15 is a partial waveform diagram of the data lines S(N+1), S(N+3) and S(N+5) depicted in FIG. 14. Referring to FIG. 2 and FIG. 15, during the sampling period T1 (the charge sharing period), the data lines S(N+1), S(N+3) and S(N+5) may share charge with one another via the first charge sharing conductor 210. After the sampling period T1 ends, the driving period T2 is entered. It is assumed that an electric quantity of the channel CH(N+1) for driving the data line S(N+1) during the driving period T2 is Q in the condition where the charge sharing is absent. In view of FIG. 15, the electric quantity of the channel CH(N+1) for driving the data line S(N+1) is reduced to approximately (⅓)Q. Although the electric quantity of the channel CH(N+3) for driving the data line S(N+3) is increased by approximately (⅓)Q, an overall driving electric quantity of the first channels (the channels CH(N+1), CH(N+3) and CH(N+5)) is approximately (⅓)Q+(⅓)Q=(⅔)Q, which is still less than the driving electric quantity Q in the condition where the charge sharing is absent.

FIG. 16 is a partial waveform diagram of the data lines S(N+2), S(N+4) and S(N+6) depicted in FIG. 14. Referring to FIG. 2 and FIG. 16, during the sampling period T1 (the charge sharing period), the data lines S(N+2), S(N+4) and S(N+6) may share charge with one another via the second charge sharing conductor 220. It is assumed that an electric quantity of the channel CH(N+2) for driving the data line S(N+2) during the driving period T2 is Q in the condition where the charge sharing is absent. In view of FIG. 16, the electric quantity of the channel CH(N+2) for driving the data line S(N+2) is reduced to approximately (⅔)Q.

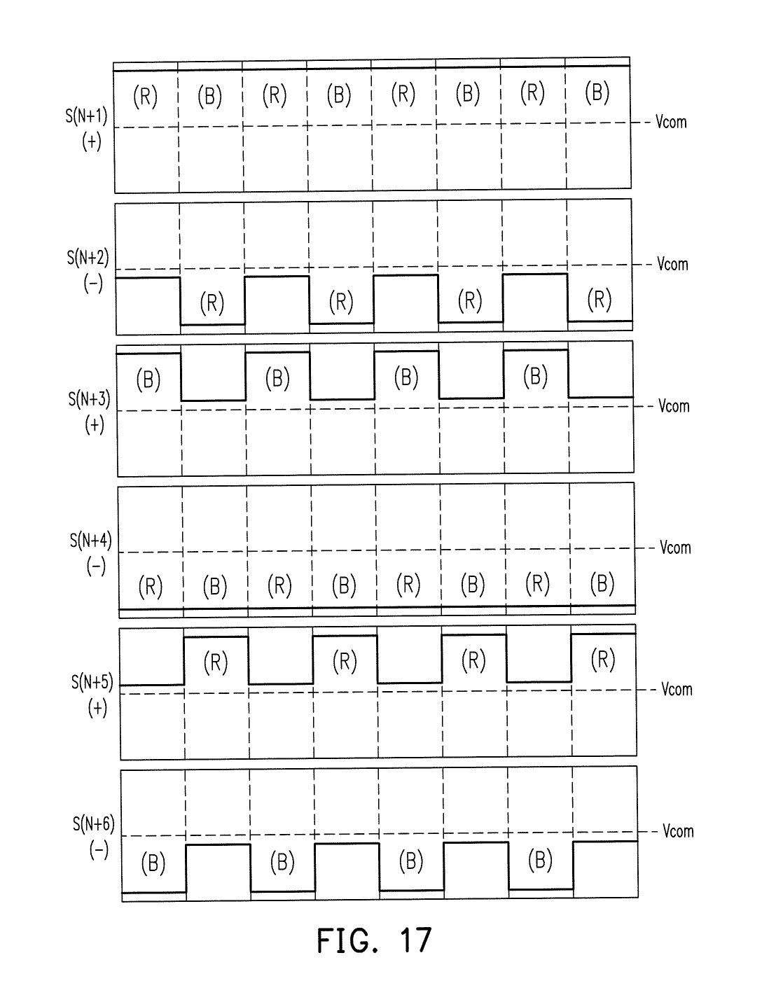

FIG. 17 illustrates a schematic diagram of waveforms when the source driver 200 depicted in FIG. 2 outputs a magenta display frame to the display panel 100 depicted in FIG. 1A according to still another embodiment of invention. In FIG. 17, a horizontal axis represents a time, and a vertical axis represent a voltage, wherein a dashed line represents a common voltage Vcom of the display panel 100. When the source driver 200 depicted in FIG. 2 outputs the magenta display frame to the display panel 100 depicted in FIG. 1A, the waveforms of the data lines S(N+1) to S(N+6) are as shown in FIG. 17.

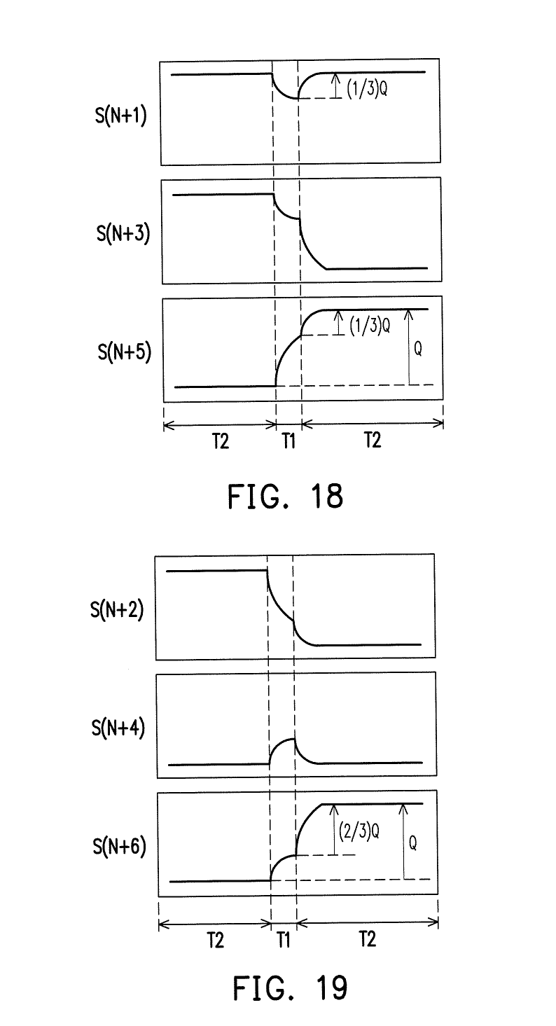

FIG. 18 is a partial waveform diagram of the data lines S(N+1), S(N+3) and S(N+5) depicted in FIG. 17. Referring to FIG. 2 and FIG. 18, during the sampling period T1 (the charge sharing period), the data lines S(N+1), S(N+3) and S(N+5) may share charge with one another via the first charge sharing conductor 210. After the sampling period T1 ends, the driving period T2 is entered. It is assumed that an electric quantity of the channel CH(N+5) for driving the data line S(N+5) during the driving period T2 is Q in the condition where the charge sharing is absent. In view of FIG. 18, the electric quantity of the channel CH(N+5) for driving the data line S(N+5) is reduced to approximately (⅓)Q. Although the electric quantity of the channel CH(N+1) for driving the data line S(N+1) is increased by approximately (⅓)Q, an overall driving electric quantity of the first channels (the channels CH(N+1), CH(N+3) and CH(N+5)) is approximately (⅓)Q+(⅓)Q=(⅔)Q, which is still less than the driving electric quantity Q in the condition where the charge sharing is absent.

FIG. 19 is a partial waveform diagram of the data lines S(N+2), S(N+4) and S(N+6) depicted in FIG. 17. Referring to FIG. 2 and FIG. 19, during the sampling period T1 (the charge sharing period), the data lines S(N+2), S(N+4) and S(N+6) may share charge with one another via the second charge sharing conductor 220. It is assumed that an electric quantity of the channel CH(N+6) for driving the data line S(N+6) during the driving period T2 is Q in the condition where the charge sharing is absent. In view of FIG. 19, the electric quantity of the channel CH(N+6) for driving the data line S(N+6) is reduced to approximately (⅔)Q.

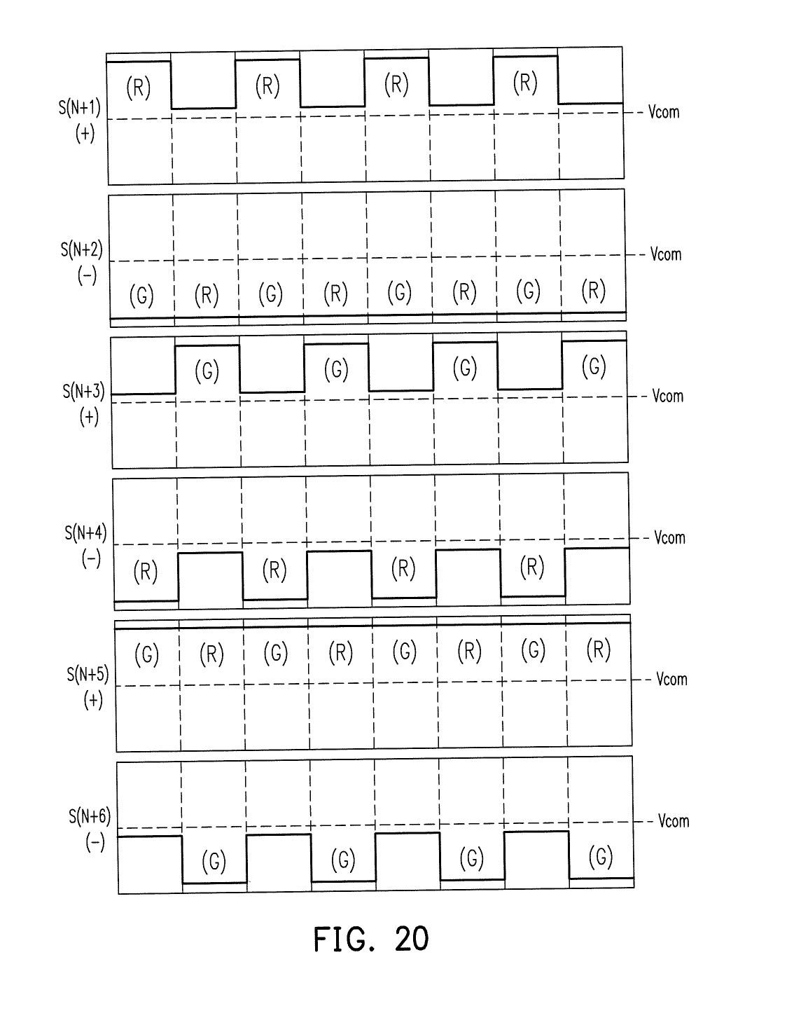

FIG. 20 illustrates a schematic diagram of waveforms when the source driver 200 depicted in FIG. 2 outputs a yellow display frame to the display panel 100 depicted in FIG. 1A according to still another embodiment of invention. In FIG. 20, a horizontal axis represents a time, and a vertical axis represent a voltage, wherein a dashed line represents a common voltage Vcom of the display panel 100. When the source driver 200 depicted in FIG. 2 outputs the yellow display frame to the display panel 100 depicted in FIG. 1A, the waveforms of the data lines S(N+1) to S(N+6) are as shown in FIG. 20.

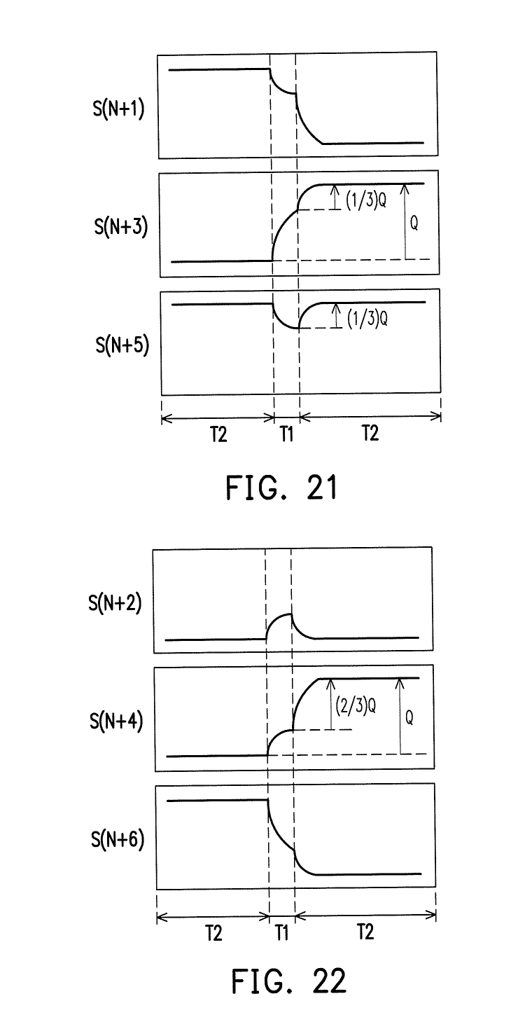

FIG. 21 is a partial waveform diagram of the data lines S(N+1), S(N+3) and S(N+5) depicted in FIG. 20. Referring to FIG. 2 and FIG. 21, during the sampling period T1 (the charge sharing period), the data lines S(N+1), S(N+3) and S(N+5) may share charge with one another via the first charge sharing conductor 210. After the sampling period T1 ends, the driving period T2 is entered. It is assumed that an electric quantity of the channel CH(N+3) for driving the data line S(N+3) during the driving period T2 is Q in the condition where the charge sharing is absent. In view of FIG. 21, the electric quantity of the channel CH(N+3) for driving the data line S(N+3) is reduced to approximately (⅓)Q. Although the electric quantity of the channel CH(N+5) for driving the data line S(N+5) is increased by approximately (⅓)Q, an overall driving electric quantity of the first channels (the channels CH(N+1), CH(N+3) and CH(N+5)) is approximately (⅓)Q+(⅓)Q=(⅔)Q, which is still less than the driving electric quantity Q in the condition where the charge sharing is absent.

FIG. 22 is a partial waveform diagram of the data lines S(N+2), S(N+4) and S(N+6) depicted in FIG. 20. Referring to FIG. 2 and FIG. 22, during the sampling period T1 (the charge sharing period), the data lines S(N+2), S(N+4) and S(N+6) may share charge with one another via the second charge sharing conductor 220. It is assumed that an electric quantity of the channel CH(N+4) for driving the data line S(N+4) during the driving period T2 is Q in the condition where the charge sharing is absent. In view of FIG. 22, the electric quantity of the channel CH(N+4) for driving the data line S(N+4) is reduced to approximately (⅔)Q.

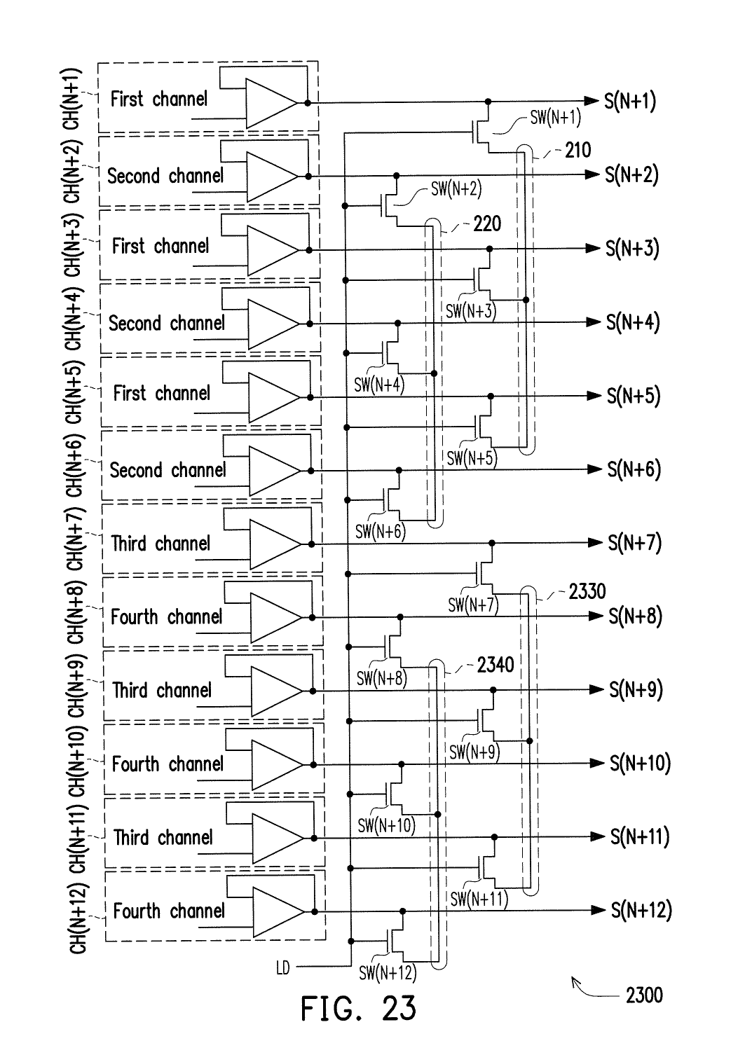

Implementations of the invention should not be limited by the source driver 200 depicted in FIG. 2. For example, FIG. 23 is a schematic diagram illustrating circuitry of a source driver 2300 according to another embodiment of the invention. The embodiment depicted in FIG. 23 may be inferred by reference with related description for FIG. 2. The source driver 2300 depicted in FIG. 23 further includes a plurality of third channels, a plurality of fourth channels, a third charge sharing conductor 2330, a fourth charge sharing conductor 2340, a plurality of third switches and a plurality of fourth switches. The third channels and the fourth channels may be disposed in the source driver 2300 by any arranged structure. For instance, in some embodiments, the third channels may be odd-numbered channels (e.g., channels CH(N+7), CH(N+9) and CH(N+11)) of the source driver 2300, and the fourth channels may be even-numbered channels (e.g., channels CH(N+8), CH(N+10) and CH(N+12)) of the source driver 2300. The channels are configured to drive different data lines of the display panel individually. For example (but the invention is not limited thereto), output terminals of the channels CH(N+7) to CH(N+12) may be respectively coupled to data lines S(N+7) to S(N+12) of the display panel. The channels CH(N+1) to CH(N+12) depicted in FIG. 23 may be inferred by reference with related description for the channel CH(N+1) depicted in FIG. 2.

During the driving period T2, outputs of the third channels (e.g., the channels CH(N+7), CH(N+9) and CH(N+11)) belong to a first polarity, and outputs of the fourth channels (e.g., the channels CH(N+8), CH(N+10) and CH(N+12)) belong to a second polarity (which is different from the first polarity). For instance, during the first frame period, the channels CH(N+1), CH(N+3), CH(N+5), CH(N+7), CH(N+9) and CH(N+11) may transmit the pixel voltage that belongs to the positive polarity to the data lines S(N+1), S(N+3), S(N+5), S(N+7), S(N+9) and S(N+11), and the channels CH(N+2), CH(N+4), CH(N+6), CH(N+8), CH(N+10) and CH(N+12) may transmit the pixel voltage that belongs to the negative polarity to the data lines S(N+2), S(N+4), S(N+6), S(N+8), S(N+10) and S(N+12). During the second frame period, the channels CH(N+1), CH(N+3), CH(N+5), CH(N+7), CH(N+9) and CH(N+11) may transmit the pixel voltage that belongs to the negative polarity to the data lines S(N+1), S(N+3), S(N+5), S(N+7), S(N+9) and S(N+11), and the channels CH(N+2), CH(N+4), CH(N+6), CH(N+8), CH(N+10) and CH(N+12) may transmit the pixel voltage that belongs to the positive polarity to the data lines S(N+2), S(N+4), S(N+6), S(N+8), S(N+10) and S(N+12).

The third charge sharing conductor 2330 is electrically isolated from the first charge sharing conductor 210 and the second charge sharing conductor 220. The fourth charge sharing conductor 2340 is electrically isolated from the first charge sharing conductor 210, the second charge sharing conductor 220 and the third charge sharing conductor 2330. First terminals of the third switches (e.g., the switches SW(N+7), SW(N+9) and SW(N+11)) are commonly coupled to the third charge sharing conductor 2330, and second terminals of the third switches are individually coupled to the output terminals of the third channels (e.g., the channels CH(N+7), CH(N+9) and CH(N+11)) in one-to-one manner. First terminals of the fourth switches (e.g., the switches SW(N+8), SW(N+10) and SW(N+12)) are commonly coupled to the fourth charge sharing conductor 2340, and second terminals of the fourth switches are individually coupled to the output terminals of the fourth channels (e.g., the channels CH(N+8), CH(N+10) and CH(N+12)) in one-to-one manner.

Control terminals of the switches SW(N+1) to SW(N+12) are commonly coupled to the same control signal (e.g., the latch signal LD). During a charge sharing period (e.g., the sampling period T1), the first switches (e.g., the switches SW(N+1), SW(N+3) and SW(N+5)) are simultaneously turned on so that the first channels (e.g., the channels CH(N+1), CH(N+3) and CH(N+5)) coupled to the first switches share charge with one another, the second switches (e.g., the switches SW(N+2), SW(N+4) and SW(N+6)) are simultaneously turned on so that the second channels (e.g., the channels CH(N+2), CH(N+4) and CH(N+6)) coupled to the second switches share charge with one another, the third switches (e.g., the switches SW(N+7), SW(N+9) and SW(N+11)) are simultaneously turned on so that the third channels (e.g., the channels CH(N+7), CH(N+9) and CH(N+11)) coupled to the third switches share charge with one another, and the fourth switches (e.g., the switches SW(N+8), SW(N+10) and SW(N+12)) are simultaneously turned on so that the fourth channels (e.g., the channels CH(N+8), CH(N+10) and CH(N+12)) coupled to the fourth switches share charge with one another.

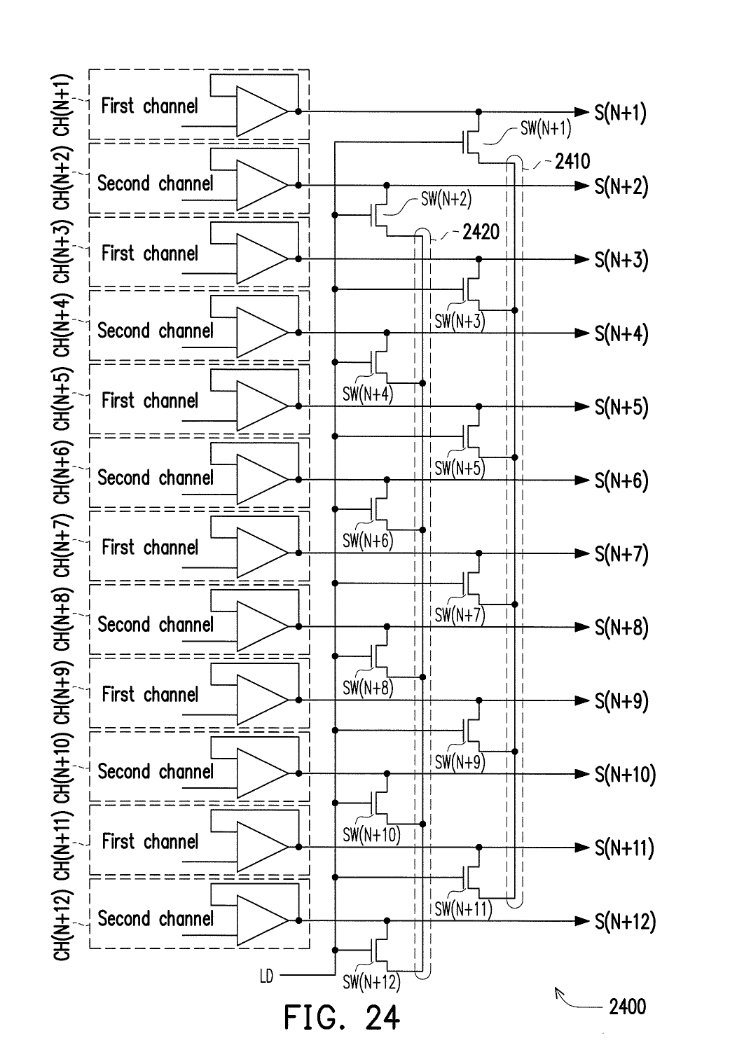

FIG. 24 is a schematic diagram illustrating circuitry of a source driver 2400 according to yet another embodiment of the invention. The embodiment depicted in FIG. 24 may be inferred by reference with related description for FIG. 2 or FIG. 23. In the embodiment depicted in FIG. 24, the source driver 2400 includes a plurality of first channels and a plurality of second channels. The first channels and the second channels may be disposed in the source driver 2400 by any arranged structure. For instance, in some embodiments, the first channels may be odd-numbered channels (e.g., channels CH(N+1), CH(N+3), CH(N+5), CH(N+7), CH(N+9) and CH(N+11)) of the source driver 2400, and the second channels may be even-numbered channels (e.g., channels CH(N+2), CH(N+4), CH(N+6), CH(N+8), CH(N+10) and CH(N+12)) of the source driver 2400. The channels are configured to drive different data lines of the display panel individually. For example (but the invention is not limited thereto), output terminals of the channels CH(N+1) to CH(N+12) may be respectively coupled to data lines S(N+1) to S(N+12) of the display panel. The channels CH(N+1) to CH(N+12) depicted in FIG. 24 may be inferred by reference with related description for the channel CH(N+1) depicted in FIG. 2.

During the driving period T2, outputs of the first channels (e.g., the channels CH(N+1), CH(N+3), CH(N+5), CH(N+7), CH(N+9) and CH(N+11)) belong to a first polarity, and outputs of the second channels (e.g., the channels CH(N+2), CH(N+4), CH(N+6), CH(N+8), CH(N+10) and CH(N+12)) belong to a second polarity (which is different from the first polarity). For instance, during the first frame period, the channels CH(N+1), CH(N+3), CH(N+5), CH(N+7), CH(N+9) and CH(N+11) may transmit the pixel voltage that belongs to the positive polarity to the data lines S(N+1), S(N+3), S(N+5), S(N+7), S(N+9) and S(N+11), and the channels CH(N+2), CH(N+4), CH(N+6), CH(N+8), CH(N+10) and CH(N+12) may transmit the pixel voltage that belongs to the negative polarity to the data lines S(N+2), S(N+4), S(N+6), S(N+8), S(N+10) and S(N+12). During the second frame period, the channels CH(N+1), CH(N+3), CH(N+5), CH(N+7), CH(N+9) and CH(N+11) may transmit the pixel voltage that belongs to the negative polarity to the data lines S(N+1), S(N+3), S(N+5), S(N+7), S(N+9) and S(N+11), and the channels CH(N+2), CH(N+4), CH(N+6), CH(N+8), CH(N+10) and CH(N+12) may transmit the pixel voltage that belongs to the positive polarity to the data lines S(N+2), S(N+4), S(N+6), S(N+8), S(N+10) and S(N+12).

A first charge sharing conductor 2410 and a second charge sharing conductor 2420 may refer to related description for the first charge sharing conductor 210 and the second charge sharing conductor 220 depicted in FIG. 2. First terminals of the first switches (e.g., the switches SW(N+1), SW(N+3), SW(N+5), SW(N+7), SW(N+9) and SW(N+11)) are commonly coupled to the first charge sharing conductor 2410, and second terminals of the first switches are individually coupled to the output terminals of the first channels (e.g., the channels CH(N+1), CH(N+3), CH(N+5), CH(N+7), CH(N+9) and CH(N+11)) in one-to-one manner. First terminals of the second switches (e.g., the switches SW(N+2), SW(N+4), SW(N+6), SW(N+8), SW(N+10) and SW(N+12)) are commonly coupled to the second charge sharing conductor 2420, and second terminals of the second switches are individually coupled to the output terminals of the second channels (e.g., the channels CH(N+2), CH(N+4), CH(N+6), CH(N+8), CH(N+10) and CH(N+12)) in one-to-one manner.

Control terminals of the switches SW(N+1) to SW(N+12) are commonly coupled to the same control signal (e.g., the latch signal LD). During a charge sharing period (e.g., the sampling period T1), the first switches (e.g., the switches SW(N+1), SW(N+3), SW(N+5), SW(N+7), SW(N+9) and SW(N+11)) are simultaneously turned on so that the first channels (e.g., the channels CH(N+1), CH(N+3), CH(N+5), CH(N+7), CH(N+9) and CH(N+11)) coupled to the first switches share charge with one another, and the second switches (e.g., the switches SW(N+2), SW(N+4), SW(N+6), SW(N+8), SW(N+10) and SW(N+12)) are simultaneously turned on so that the second channels (e.g., the channels CH(N+2), CH(N+4), CH(N+6), CH(N+8), CH(N+10) and CH(N+12)) coupled to the second switches share charge with one another.

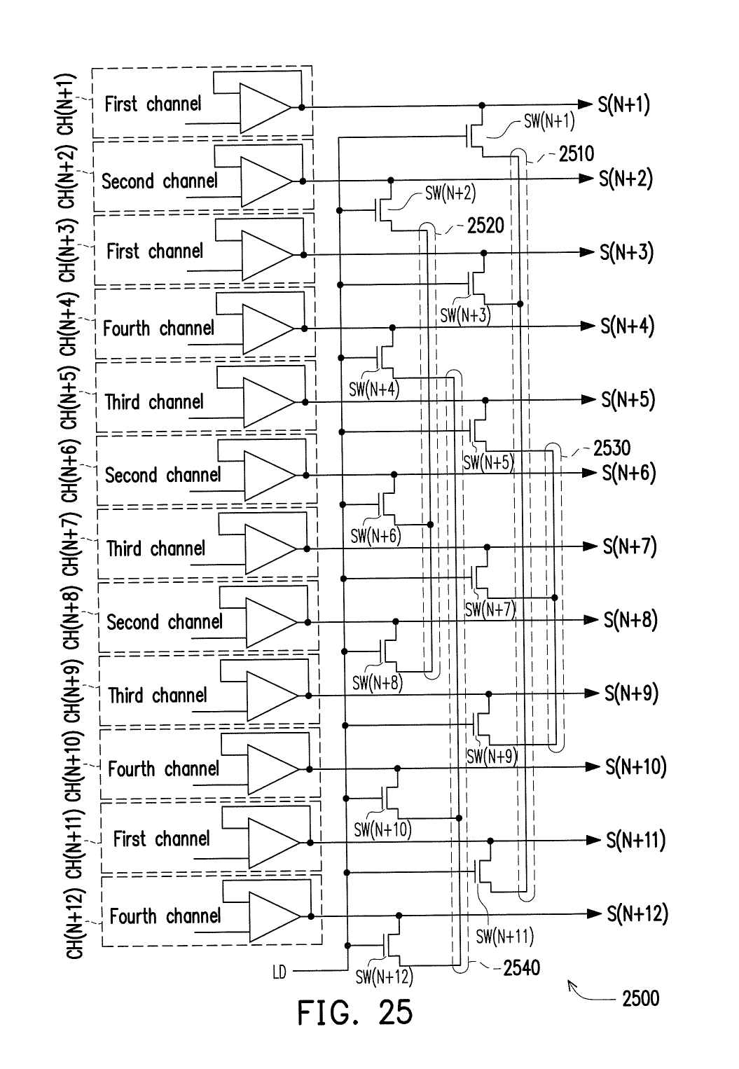

In other embodiments, a plurality of channels commonly coupled to the same charge sharing conductor may be any channels that belong to the same polarity. For instance, FIG. 25 is a schematic diagram illustrating circuitry of a source driver 2500 according to still another embodiment of the invention. The embodiment depicted in FIG. 25 may be inferred by reference with related description for FIG. 2 or FIG. 23. The source driver 2500 depicted in FIG. 25 includes a plurality of first channels, a plurality of second channels, a plurality of third channels and a plurality of fourth channels. The first channels, the second channels, the third channels and the fourth channels may be disposed in the source driver 2500 by any arranged structure. In the example illustrated in FIG. 25, the first channels may be channels CH(N+1), CH(N+3) and CH(N+11) of the source driver 2500, the second channels may be channels CH(N+2), CH(N+6) and CH(N+8) of the source driver 2500, the third channels may be channels CH(N+5), CH(N+7) and CH(N+9) of the source driver 2500, and the fourth channels may be channels CH(N+4), CH(N+10) and CH(N+12) of the source driver 2500. Output terminals of the channels CH(N+1) to CH(N+12) may be respectively coupled to data lines S(N+1) to S(N+12) of the display panel. The channels CH(N+1) to CH(N+12) depicted in FIG. 25 may be inferred by reference with related description for the channel CH(N+1) depicted in FIG. 2.

During the driving period T2, outputs of the first channels (e.g., the channels CH(N+1), CH(N+3) and CH(N+11) and the third channels (e.g., the channels CH(N+5), CH(N+7) and CH(N+9)) belong to a first polarity, and outputs of the second channels (e.g., the channels CH(N+2), CH(N+6) and CH(N+8) and the fourth channels (e.g., the channels CH(N+4), CH(N+10) and CH(N+12)) belong to a second polarity (which is different from the first polarity). For instance, during the first frame period, the channels CH(N+1), CH(N+3), CH(N+5), CH(N+7), CH(N+9) and CH(N+11) may transmit the pixel voltage that belongs to the positive polarity to the data lines S(N+1), S(N+3), S(N+5), S(N+7), S(N+9) and S(N+11), and the channels CH(N+2), CH(N+4), CH(N+6), CH(N+8), CH(N+10) and CH(N+12) may transmit the pixel voltage that belongs to the negative polarity to the data lines S(N+2), S(N+4), S(N+6), S(N+8), S(N+10) and S(N+12). During the second frame period, the channels CH(N+1), CH(N+3), CH(N+5), CH(N+7), CH(N+9) and CH(N+11) may transmit the pixel voltage that belongs to the negative polarity to the data lines S(N+1), S(N+3), S(N+5), S(N+7), S(N+9) and S(N+11), and the channels CH(N+2), CH(N+4), CH(N+6), CH(N+8), CH(N+10) and CH(N+12) may transmit the pixel voltage that belongs to the positive polarity to the data lines S(N+2), S(N+4), S(N+6), S(N+8), S(N+10) and S(N+12).

The source driver 2500 depicted in FIG. 25 further includes a first charge sharing conductor 2510, a second charge sharing conductor 2520, a third charge sharing conductor 2530, a fourth charge sharing conductor 2540, a plurality of first switches (e.g., switches SW(N+1), SW(N+3) and SW(N+1)), a plurality of second switches (e.g., switches SW(N+2), SW(N+6) and SW(N+8)), a plurality of third switches (e.g., switches SW(N+5), SW(N+7) and SW(N+9)) and a plurality of fourth switches (e.g., switches SW(N+4), SW(N+10) and SW(N+12)). The charge sharing conductors 2510, 2520, 2530 and 2540 are electrically isolated from one another. First terminals of the switches SW(N+1), SW(N+3) and SW(N+11) are coupled to the first charge sharing conductor 2510, and second terminals of the switches SW(N+1), SW(N+3) and SW(N+11) are individually coupled to the output ten finals of the channels CH(N+1), CH(N+3) and CH(N+11) in one-to-one manner. First terminals of the switches SW(N+2), SW(N+6) and SW(N+8) are coupled to the second charge sharing conductor 2520, and second terminals of the switches SW(N+2), SW(N+6) and SW(N+8) are individually coupled to the output terminals of the channels CH(N+2), CH(N+6) and CH(N+8) in one-to-one manner. First terminals of the switches SW(N+5), SW(N+7) and SW(N+9) are commonly coupled to the third charge sharing conductor 2530, and second terminals of the switches SW(N+5), SW(N+7) and SW(N+9) are individually coupled to the output terminals of the channels CH(N+5), CH(N+7) and CH(N+9) in one-to-one manner. First terminals of the switches SW(N+4), SW(N+10) and SW(N+12) are commonly coupled to the fourth charge sharing conductor 2540, and second terminals of the switches SW(N+4), SW(N+10) and SW(N+12) are individually coupled to the output terminals of the channels CH(N+4), CH(N+10) and CH(N+12) in one-to-one manner.

Control terminals of the switches SW(N+1) to SW(N+12) are commonly coupled to the same control signal (e.g., the latch signal LD). During a charge sharing period (e.g., the sampling period T1), the switches SW(N+1), SW(N+3) and SW(N+11) are simultaneously turned on so that the channels CH(N+1), CH(N+3) and CH(N+11) share charge with one another, the switches SW(N+2), SW(N+6) and SW(N+8) are simultaneously turned on so that the channels CH(N+2), CH(N+6) and CH(N+8) share charge with one another, the switches SW(N+5), SW(N+7) and SW(N+9) are simultaneously turned on so that the channels CH(N+5), CH(N+7) and CH(N+9) share charge with one another, and the switches SW(N+4), SW(N+10) and SW(N+12) are simultaneously turned on so that the channels CH(N+4), CH(N+10) and CH(N+12) share charge with one another.

The following is a description of the control method of the source driver comprising the first channels and the second channels. The first switches are individually coupled to the first channels, and the second switches are individually coupled to the second channels. The control method comprises: receiving a control signal by the first switches and the second switches to determine a charge sharing mode, wherein the first channels share charge with each other when the first switches is turned on, and the second channels share charge with each other when the second switches is turned on.

In some embodiments (but not limited to), the control method further includes: electrically insulating the first channels from the second channels.

In some embodiments (but not limited to), the control method further includes: turning on the first switches and the second switches during a charge sharing period.

In some embodiments (but not limited to), the first channels are odd-numbered channels, and the second channels are even-numbered channels.

In some embodiments (but not limited to), during a driving period, outputs of the first channels belong to a first polarity, and outputs of the second channels belong to a second polarity different from the first polarity.

In summary, the source driver and the display device according to the embodiments of the invention are capable of allowing the channels that belong to the same polarity to share charge with one another via the charge sharing conductors. Said charge sharing is unrelated to the content of the image frame processed by the source driver. The charge sharing switches (e.g., the switches SW(N+1) to SW(N+12) as described in the foregoing embodiments) may be turned on once per one scan line period TL regardless of whether the polarity inversion occurs or not.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver, comprising:
a plurality of first channels and a plurality of second channels, configured to drive different data lines of a display panel individually, wherein during a driving period, outputs of the first channels belong to a first polarity, and outputs of the second channels belong to a second polarity different from the first polarity;
a first charge sharing conductor;
a second charge sharing conductor, electrically isolated from the first charge sharing conductor;
a plurality of first switches, having first terminals coupled to the first charge sharing conductor, and second terminals of the first switches being individually coupled to output terminals of the first channels in one-to-one manner; and
a plurality of second switches, having first terminals coupled to the second charge sharing conductor, and second terminals of the second switches being individually coupled to output terminals of the second channels in one-to-one manner.

2. The source driver of claim 1, wherein during a charge sharing period, the first switches are simultaneously turned on so that the first channels coupled to the first switches share charge with one another, and the second switches are simultaneously turned on so that the second channels coupled to the second switches share charge with one another.

3. The source driver of claim 2, wherein the charge sharing period occurs within each period among a plurality of consecutive scan line periods.

4. The source driver of claim 1, wherein control terminals of the first switches and control terminals of the second switches are commonly coupled to a control signal.

5. The source driver of claim 4, wherein the source driver latches image data according to a latch signal, and wherein the latch signal is provided as the control signal.

6. The source driver of claim 1, wherein on and off states of the first switches and the second switches are unrelated to a content of an image frame processed by the source driver.

7. The source driver of claim 1, wherein the first channels are odd-numbered channels, and the second channels are even-numbered channels.

8. The source driver of claim 1, wherein a number of the first channels is a positive integer greater than 2, and a number of the second channels is a positive integer greater than 2.

9. The source driver of claim 1, wherein a number of the first channels is equal to a number of the second channels.

10. The source driver of claim 1, wherein the source driver drives the display panel by a column inversion mode.

11. The source driver of claim 1, further comprising:
a plurality of third channels and a plurality of fourth channels, configured to drive different data lines of the display panel individually, wherein during the driving period, outputs of the third channels belong to the first polarity, and outputs of the fourth channels belong to the second polarity;
a third charge sharing conductor, electrically isolated from the first charge sharing conductor and the second charge sharing conductor;
a fourth charge sharing conductor, electrically isolated from the first charge sharing conductor, the second charge sharing conductor and the third charge sharing conductor;
a plurality of third switches, having first terminals coupled to the third charge sharing conductor, and second terminals of the third switches being individually coupled to output terminals of the third channels in one-to-one manner; and
a plurality of fourth switches, having first terminals coupled to the fourth charge sharing conductor, and second terminals of the fourth switches being individually coupled to output terminals of the fourth channels in one-to-one manner.

12. The source driver of claim 11, wherein during a charge sharing period, the first switches are simultaneously turned on so that the first channels coupled to the first switches share charge with one another, the second switches are simultaneously turned on so that the second channels coupled to the second switches share charge with one another, the third switches are simultaneously turned on so that the third channels coupled to the third switches share charge with one another, and the fourth switches are simultaneously turned on so that the fourth channels coupled to the fourth switches share charge with one another.

13. The source driver of claim 11, wherein control terminals of the first switches, the second switches, the third switches and the fourth switches are commonly coupled to a control signal.

14. A source driver, comprising:
a plurality of first channels and a plurality of second channels, configured to drive different data lines of a display panel individually, wherein during a driving period, outputs of the first channels belong to a first polarity, and outputs of the second channels belong to a second polarity different from the first polarity;
one or more first charge sharing conductors;
one or more second charge sharing conductors, electrically isolated from the one or more first charge sharing conductors;
one or more first switch groups, respectively corresponding to the one or more first charge sharing conductors, wherein each of the one or more first switch groups includes a plurality of first switches, first terminals of the first switches are coupled to the corresponding first charge sharing conductor, and second terminals of the first switches are individually coupled to output terminals of the first channels in one-to-one manner; and
one or more second switch groups, respectively corresponding to the one or more second charge sharing conductors, wherein each of the one or more second switch groups includes a plurality of second switches, first terminals of the second switches are coupled to the corresponding second charge sharing conductor, and second terminals of the second switches are individually coupled to output terminals of the second channels in one-to-one manner.

15. The source driver of claim 14, wherein during a charge sharing period, the first switches in each of the one or more first switch groups are simultaneously turned on so that the first channels coupled to the first switches share charge with one another, and the second switches in each of the one or more second switch groups are simultaneously turned on so that the second channels coupled to the second switches share charge with one another.

16. The source driver of claim 14, wherein the first channels are odd-numbered channels, and the second channels are even-numbered channels.

17. The source driver of claim 14, wherein control terminals of the first switches in each of the one or more first switch groups and control terminals of the second switches in each of the one or more second switch groups are commonly coupled to a control signal.

18. A display device, comprising:
a display panel; and
a source driver for driving the display panel, wherein the source driver comprises:
a plurality of first channels and a plurality of second channels, configured to drive different data lines of the display panel individually, wherein during a driving period, outputs of the first channels belong to a first polarity, and outputs of the second channels belong to a second polarity different from the first polarity;
a first charge sharing conductor;
a second charge sharing conductor, electrically isolated from the first charge sharing conductor;
a plurality of first switches, having first terminals coupled to the first charge sharing conductor, and second terminals of the first switches being individually coupled to output terminals of the first channels in one-to-one manner; and
a plurality of second switches, having first terminals coupled to the second charge sharing conductor, and second terminals of the second switches being individually coupled to output terminals of the second channels in one-to-one manner.

19. The display device of claim 18, wherein the display panel has a Zigzag pixel structure.

20. The display device of claim 18, wherein control terminals of the first switches and control terminals of the second switches are commonly coupled to a control signal.

21. A control method of a source driver comprising a plurality of first channels and a plurality of second channels, a plurality of first switches individually coupled to the first channels, a plurality of second switches individually coupled to the second channels, and the control method comprising:
receiving a control signal by the first switches and the second switches to determine a charge sharing mode, wherein the first channels share charge with each other when the first switches is turned on, and the second channels share charge with each other when the second switches is turned on.

22. The control method of claim 21, further comprising:
electrically insulating the first channels from the second channels.

23. The control method of claim 21, further comprising:
turning on the first switches and the second switches during a charge sharing period.

24. The control method of claim 21, wherein the first channels are odd-numbered channels, and the second channels are even-numbered channels.

25. The control method of claim 21, wherein during a driving period, outputs of the first channels belong to a first polarity, and outputs of the second channels belong to a second polarity different from the first polarity.
